(19) United States
(12) Patent Application Publication
(10) Pub. No.: US 2024/0117643 A1
(43) Pub. Date: Apr. 11, 2024

(54) HOIST AND HOIST ELEVATOR AND CONTROL SYSTEM

(71) Applicant: Quiet Solutions Ltd, Tel-Aviv (IL)

(72) Inventors: Amitai BEN HAMO, Jerusalem (IL); Daniel TOPAZ, Tel-Aviv (IL); Yaron LEMELBAUM, Tel Aviv (IL)

(73) Assignee: Quiet Solutions Ltd, Tel-Aviv (IL)

(21) Appl. No.: 18/270,264

(22) PCT Filed: Dec. 30, 2021
(86) PCT No.: PCT/IL2021/051557

§ 371 Date: Jun. 29, 2023

(30) Foreign Application Priority Data
Dec. 31, 2020 (IL) 279900

(51) Int. Cl. E04G 3/32; B66B 1/34; B66B 5/02; B66B 5/14; E04G 21/16

(52) U.S. Cl. CPC E04G 3/32; B66B 1/3461; B66B 5/022; B66B 5/145; E04G 21/166; B66B 2201/102; B66B 2201/222

(57) ABSTRACT

A hoist elevator control system and a hoist elevator for a multi-story building structure on a building site, comprises an enclosure for raising and lowering personnel and materials. The control system comprises a sensor external to the enclosure, a sensor internal to the enclosure, a call button at each floor, and a processor located within the enclosure. The processor obtains data from the sensors and the call buttons and provides output to a display screen in the enclosure and to an external control location. The internal sensor may be a people counter that issues an alarm to prevent operation when the enclosure has more than a preset number of people within. The people counter may send the current number of people within to the processor for processing, and data may allow an operator to control the elevator, for example via a cloud connection and/or a telephone application.

### RELATED APPLICATION

This application claims the benefit of priority of Israel Patent Application No. 279900 filed on 31 Dec. 2020, the contents of which are incorporated herein by reference in their entirety.

### FIELD AND BACKGROUND OF THE INVENTION

The present invention, in some embodiments thereof, relates to a hoist or hoist elevator and control mechanism of the kind that may be used on a building site.

Hoists and associated hoist mechanisms are used to raised materials to heights on building sites. In general if it is only required to raise materials, then all that is needed is a platform and the result is a hoist. If personnel are to be raised as well then an enclosed cabin is required, and what is provided is a hoist lift or a hoist elevator.

A hoist elevator is commonly used on large scale construction projects, such as high-rise buildings or major hospitals, the purpose being to carry personnel, materials, and equipment quickly between the ground and higher floors, or between floors in the middle of a structure.

The hoist elevator may be made up of either one or two cars or cages which travel vertically along stacked mast tower sections. The mast sections are attached to the structure or building, say every 7.62 m, for added stability. For precisely controlled travel along the mast sections, modern construction hoists use a motorized rack-and-pinion system that climbs the mast sections at various speeds. The elevator itself is an enclosure, which is simply a box that is raised and lowered and may or may not be electrically connected to anything. Contrary to conventional elevators, generally hoist elevators require manual operation of the doors. Since the hoists are assembled on site there are none of the sophisticated mechanisms that allow a conventional elevator to know what floor it is on.

In any building site over a certain height, a hoist is required, for example eight floors.

As the construction is external, a further legal requirement is that the hoist may not be used when windspeeds are above a certain limit, for example 40 kmh. Whenever the windspeed is above the legal limit, any heavy lifting on the building site is stopped and building personnel at elevations have to find their own way down.

In the past, the hoist mechanism was operated by a human operator, who would send the hoist to the required floor. Bells and like systems would be used to indicate to the operator which floor was required.

In recent years, improved hoist control systems have been provided including calling of the elevator. Having a human operator is still a legal requirement, however instead of ringing a mechanical bell, a call system is provided so that building site staff may press a button to call the elevator. Wiring the call system is possible but it must be borne in mind that the building site changes as more stories are built, and a wired system is inflexible. Thus the level of automation that can be provided is necessarily limited and elevator wait times (EWT) are currently subject to the efficiency of the operator. In some countries and locations there may not be a mains electricity supply.

### SUMMARY OF THE INVENTION

The present embodiments relate to improving the efficiency of the hoist elevator and reducing the level of reliance on the human operator. Algorithmic and programmable control may improve EWT. Furthermore, wireless wind detection at elevation may be used to shut down elevator operation at elevations where the windspeed is above the limit but retain operation at lower elevations so that the wind does not paralyze operation of the entire building site.

According to an aspect of some embodiments of the present invention there is provided a hoist elevator control system for a hoist elevator attached to a multi-story building structure, the elevator comprising an enclosure for raising and lowering personnel and materials in the multi-story structure, the control system comprising at least one sensor external to the enclosure, at least one sensor internal to the enclosure, a call button at each floor, and a processor located within the enclosure, the processor configured to obtain data from each of the at least one sensor internal to the enclosure, the at least one sensor external to the controller and the call buttons and to output data to a display screen in the enclosure and to an external control location, thereby to control the elevator. The at least one internal sensor may be a people counter, the people counter being configured to issue an alarm to prevent operation when the enclosure has more than a preset number of people within, the people counter further configured to send a current number of people within to the processor for processing.

In an embodiment, the at least one external sensor is a windspeed detector, the windspeed detector being configured to issue an alarm to prevent operation of the hoist elevator when a detected windspeed is above a predetermined limit.

Embodiments may comprise a windspeed detector located on the elevator, or alternatively windspeed detectors at different heights, the control system configured to indicate safe operation of the hoist elevator only up to floors below a height at which a detected windspeed is above a predetermined level.

In an embodiment, the at least one external sensor is a door status sensor to detect whether a door at a given floor is open or closed, to indicate a floor at which the door is open.

In an embodiment, some of the call buttons are bidirectional call buttons, the control system being configured to use direction information from the call buttons to calculate a next floor for the elevator.

In an embodiment, the processor is at least partly battery powered, or is at least partly powered by a solar panel.

According to a second aspect of the present invention there is provided a hoist elevator control system for a hoist elevator attached to a multi-story building structure, the elevator comprising an enclosure for raising and lowering personnel and materials in the multi-story structure, the control system comprising a processor located within the enclosure, and a plurality of windspeed sensors at different heights on the structure, the processor configured to obtain data from the windspeed sensors and to allow operation of the hoist elevator only up to a floor below a height at which a corresponding one of the windspeed sensors detects a windspeed above a predetermined limit.

The windspeed detectors may be wirelessly connected anemometers.

One further aspect of the invention may relate to a cloud based processing application for cloud based operation of one or more hoist elevator control systems as discussed herein.

A further aspect of the invention may relate to a user application located on a mobile computing device for wireless operation of one or more hoist elevator control systems discussed herein.

A further aspect of the present invention relates to a hoist elevator control method for a hoist elevator attached to a multi-story building structure, the elevator comprising an enclosure for raising and lowering personnel and materials in the multi-story structure, the control method comprising: receiving data from at least one sensor external to the enclosure;
receiving data from at least one sensor internal to the enclosure;
wirelessly receiving calls from call buttons at each floor;
outputting to a display screen in the enclosure indications of a current floor and a next floor at which the elevator stops; and
wirelessly outputting data to an external location.

A further aspect of the present invention relates to a hoist elevator control system, a hoist elevator and an application for a telephone, the hoist elevator attached to a multi-story building structure of an incomplete building on a building site, the elevator comprising an enclosure for raising and lowering personnel and materials between floors of said multi-story structure, the control system comprising at least one sensor external to said enclosure, at least one sensor internal to said enclosure, and a processor located within the enclosure, the processor configured to obtain data from each of said at least one sensor internal to said enclosure, said at least one sensor external to said controller, and to output data to a display screen in said enclosure and to an external control location, the control system being configured to open a communication channel with said telephone application to control said hoist elevator from said telephone application.

A yet further aspect of the present invention relates to a hoist elevator control method for a hoist elevator attached to a multi-story building structure, the elevator comprising an enclosure for raising and lowering personnel and materials in the multi-story structure, the method comprising:
obtaining data from a plurality of windspeed sensors at different heights on the structure; and
allowing operation of the hoist elevator only up to a floor below a height at which a corresponding one of the windspeed sensors detects a windspeed above a predetermined limit.

Unless otherwise defined, all technical and/or scientific terms used herein have the same meaning as commonly understood by one of ordinary skill in the art to which the invention pertains. Although methods and materials similar or equivalent to those described herein can be used in the practice or testing of embodiments of the invention, exemplary methods and/or materials are described below. In case of conflict, the patent specification, including definitions, will control. In addition, the materials, methods, and examples are illustrative only and are not intended to be necessarily limiting.

Implementation of the method and/or system of embodiments of the invention can involve performing or completing selected tasks manually, automatically, or a combination thereof. Moreover, according to actual instrumentation and equipment of embodiments of the method and/or system of the invention, several selected tasks could be implemented by hardware, by software or by firmware or by a combination thereof using an operating system.

For example, hardware for performing selected tasks according to embodiments of the invention could be implemented as a chip or a circuit. As software, selected tasks according to embodiments of the invention could be implemented as a plurality of software instructions being executed by a computer using any suitable operating system. In an exemplary embodiment of the invention, one or more tasks according to exemplary embodiments of method and/or system as described herein are performed by a data processor, such as a computing platform for executing a plurality of instructions. Optionally, the data processor includes a volatile memory for storing instructions and/or data and/or a non-volatile storage, for example, a magnetic hard-disk and/or removable media, for storing instructions and/or data. Optionally, a network connection is provided as well. A display and/or a user input device such as a keyboard or mouse are optionally provided as well.

### BRIEF DESCRIPTION OF THE SEVERAL VIEWS OF THE DRAWING(S)

Some embodiments of the invention are herein described, by way of example only, with reference to the accompanying drawings. With specific reference now to the drawings in detail, it is stressed that the particulars shown are by way of example and for purposes of illustrative discussion of embodiments of the invention. In this regard, the description taken with the drawings makes apparent to those skilled in the art how embodiments of the invention may be practiced.

In the drawings:

FIG. 1 is a simplified diagram of a prior art hoist elevator;

FIG. 2 is a simplified block diagram showing the elements of a control system for the hoist elevator of FIG. 1;

FIG. 3 is a simplified block diagram illustrating a hoist elevator according to an embodiment of the present invention;

FIG. 4 is a simplified block diagram showing the elements of a control system for the hoist elevator of FIG. 3;

FIG. 5 is a simplified flow chart showing a method of operation of a control system for a hoist elevator according to embodiments of the present invention;

FIG. 6 is a simplified flow chart showing a second method of operation of a control system for a hoist elevator according to embodiments of the present invention; and

FIG. 7 is a simplified diagram showing an exemplary screen of an application for operating a hoist elevator according to the present embodiments.

### DESCRIPTION OF SPECIFIC EMBODIMENTS OF THE INVENTION

The present invention, in some embodiments thereof, relates to a hoist or hoist elevator and, more particularly, but not exclusively, to automation of hoists at locations such as building sites.

A hoist elevator control system is provided for a hoist elevator attached to a multi-story building structure the elevator being an enclosure for raising and lowering personnel and materials between floors in the multi-story structure. The control system comprises sensors external to the enclosure, sensors internal to the enclosure, a call button at each floor, and a processor located within the enclosure. The processor obtains data from the internal and external sensors and the call buttons and outputs data to a display screen in the enclosure and to an external control location and allows the operator to control the elevator accordingly. In embodiments the processor may control the elevator directly.

Communication between the enclosure and the external sensors and locations may be wireless, although wired connections may be used internally to the enclosure.

The sensors may include one or more windspeed sensors. The operation of the elevator may be prevented, typically by the operator, if the measured windspeed is above a preset threshold. In an embodiment, a windspeed sensor is placed on the elevator to obtain windspeeds at various heights. In an alternative embodiment, multiple windspeed sensors are provided at different heights, and the operator may restrict operation of the elevator to floors below a lowest height at which a windspeed above the threshold is measured. The windspeed sensor, or sensors, may be wired or wirelessly connected to the elevator control, and may be an anemometer.

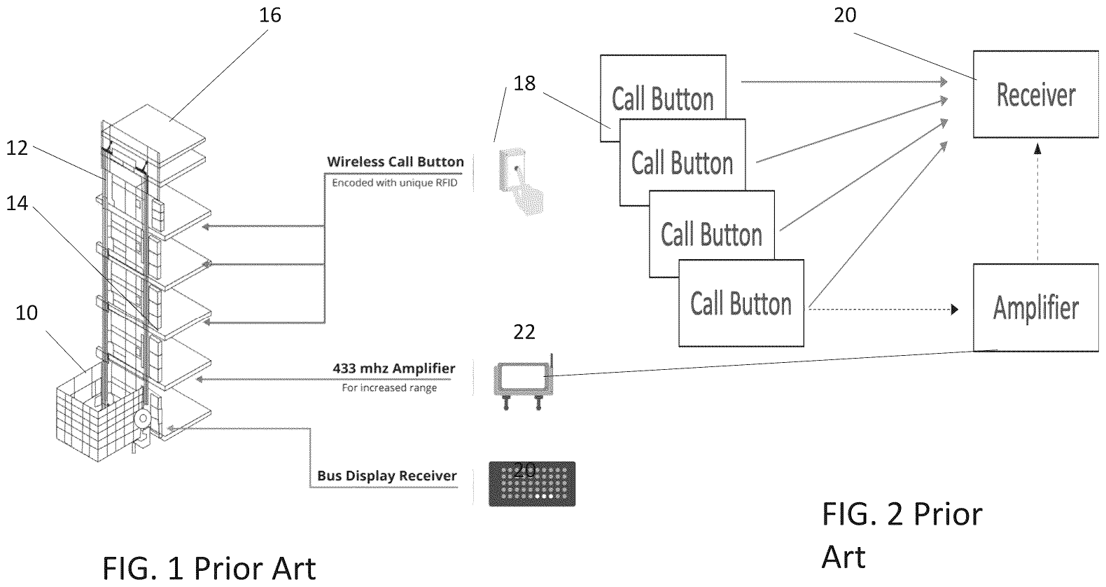

Referring now to the drawings, FIG. 1 illustrates a hoist elevator for a building site according to the existing art. The hoist elevator consists of an enclosure 10 that rides on rails 12 and 14 up the side of a structure 16 that is being built. The rails are attached at regular intervals to the structure.

At each floor, a wireless call button 18 is placed. As discussed, it is inadvisable to wire a structure under construction for electricity so that each call button is a standalone wireless unit, allowing for a call to be sent to the operator.

The system of FIG. 1 adds an RFID device into each call button, and an RFID detector and bus display receiver 20 is placed within the elevator to detect the closest call button and thus display the current floor. Thus a call button is placed at each floor, and in addition an amplifier 22 may be added at regular intervals, to increase reception range if needed. The RFID may typically operate at 433 MHz.

Reference is now made to FIG. 2, which is a simplified block diagram illustrating the wireless connections between the call buttons 18 and the receiver 20, mediated when necessary by the amplifier 22. A simple RFID transmission allows the elevator to identify the nearest floor for display to passengers within the elevator.

Before explaining at least one embodiment of the invention in detail, it is to be understood that the invention is not necessarily limited in its application to the details of construction and the arrangement of the components and/or methods set forth in the following description and/or illustrated in the drawings and/or the Examples. The invention is capable of other embodiments or of being practiced or carried out in various ways.

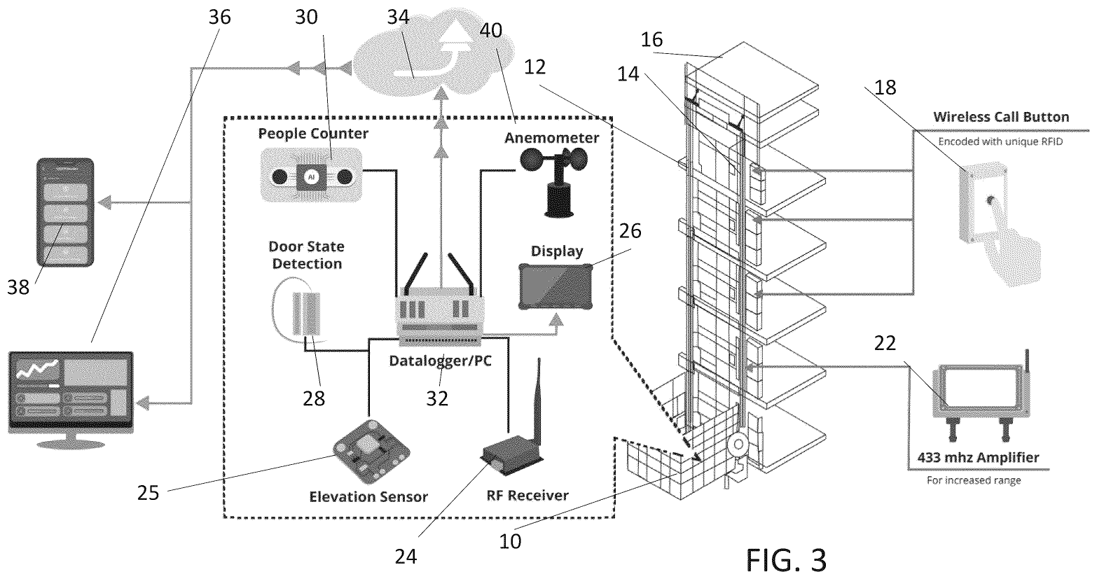

Reference is now made to FIG. 3, which is a schematic illustration of an embodiment of a hoist elevator according to the present invention. As before, the hoist elevator consists of an enclosure 10 that rides on rails 12 and 14 up the side of the structure 16.

At each floor, a wireless call button 18 is placed, and each call button may include a unique RFID, allowing the current floor to be identified when the RFID signal is picked up at wireless receiver 24 within the elevator. The call button may be bi-directional, allowing the caller to ask for up or down directions, which may allow for algorithmic calculation of the next floor. In this case, the separate up and down buttons may have separate RFIDs, so that both the calling floor and required direction are obtained. Elevation sensor 25 may indicate a current elevation and thus the floor at which the elevator is located, even though the door may not be open. The current floor and the next floor and any other status information may be displayed on display 26, which display is located within the elevator. Door state detection unit 28 detects whether the doors are open or closed. Existing safety mechanisms prevent operation when a door is open, but do not indicate which door is open. Thus with door detection unit 28 the location of the problem door may be instantaneously provided. As will be discussed in greater detail below, the door state detection relates to doors on the building structure, so that there is per floor detection.

In addition, a people counter 30 may provide a count of the number of persons in the elevator, for example to prevent motion of the elevator if too full or simply to provide data. When the door detection unit 28 indicates that the door is open, the people counter starts counting the number of people entering and exiting, so that the numbers of entries and exists at given floors at given times of the day may be introduced to provide material for self-learning of the algorithm. Datalogger 32, or a built-in processor or PC, may provide a central control within the elevator to connect the various elements and direct data to the correct destination. For example, the data logger may send monitoring information to a location in the cloud 34 for processing and storage or sending on to a control location 36 or the like for the attention of the operator. A mobile app may be provided to allow for control of the elevator 10 via a mobile telephone 38, which may supply control instructions in the return direction, typically from the operator, by sending instructions directly or via the cloud.

In addition, an anemometer 40 may be located externally to the elevator 10 or structure 16 to provide windspeed information. The anemometer may transmit its data to the datalogger 32 and if the windspeed is above the regulation limit then use of the elevator may be prevented. If separate anemometers are provided at different elevations then the elevator may be allowed to continue to be used up to the highest floor where the windspeed is measured to be below the limit, and thus a high windspeed at the highest elevation does not shut down the entire operation. Likewise if the anemometer is fixed to the elevator, readings taken while the elevator is at different floors may be used to define the highest height that the elevator is allowed to reach.

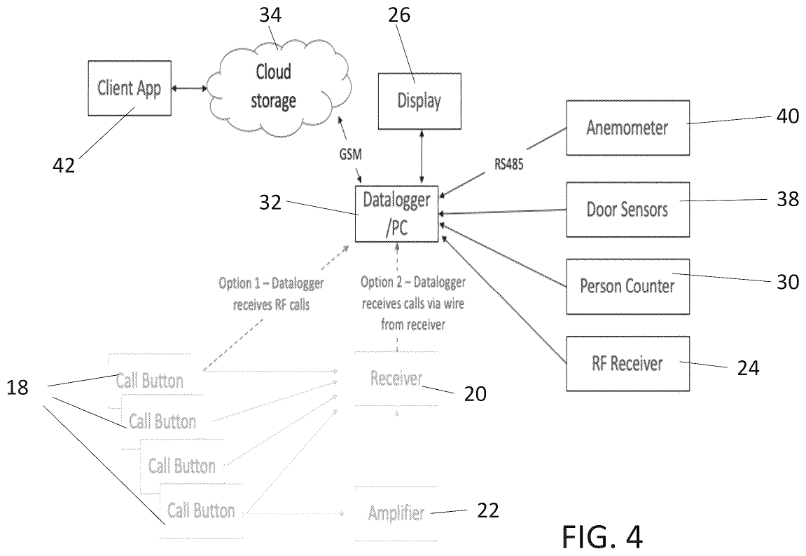

Reference is now made to FIG. 4, which is a simplified system diagram illustrating the interactions of the embodiment of FIG. 3. Parts that are the same as in the previous figures are given the same reference numerals and are described only as necessary for an understanding of the present figure. As shown, the datalogger or other processor or PC 32 is the heart of the system inside the elevator. The datalogger receives signals from the RF receiver 24, which in turn receives the RFID signals from the amplifier 22 or directly from the call buttons 18.

As shown, in a variation, the receiver may be dispensed with and datalogger 32 may receive the RFID signals directly from the call buttons 18.

In a further variation, rather than the datalogger 32 receiving a signal wirelessly from receiver 24, the datalogger may receive a signal via wire from receiver 20. The signal from the call button may be relayed via amplifier or repeater 22 as needed, and the use of amplifier—repeater 22 may apply to any of the variations discussed herein.

The door state detector, or door sensor, 38, person counter 30 and anemometer or anemometers 40 all send data to the datalogger 32 as discussed above. The datalogger 32 then outputs data to display 26 and to the cloud 34 for storage and processing. The cloud system may then communicate with a client app 42 which may run on any computing device including a mobile computing device such as a mobile telephone.

The datalogger and other components in the elevator enclosure may be battery powered. Additionally or alternatively the components may be solar powered, and a solar panel may be placed on the structure or on the enclosure itself, the latter to save any unnecessary and potentially dangerous wiring. Solar power may be used to charge batteries during the day so that the system may operate during the night.

In the classic hoist system, the operator closes the doors on ascending personnel and material or equipment and sends the elevator to the required floor. Subsequently, when hearing the bell from a given floor, the operator sends the elevator to that floor to bring the personnel etc down. Known systems improve on the classical system in that instead of hearing a mechanical bell, the operator may receive the call from an individual floor electronically, but the sending of the elevator to any given floor is carried out manually in the same way.

In the present embodiments, the use of the datalogger, bidirectional calling and cloud processing permits for algorithmic floor selection. Thus if personnel at say the 14^{th} and 15^{th} floor call the elevator at the same time, an algorithm may determine that both calls want to reach the ground floor and may determine a suitable route, collecting from the 15^{th} and then the 14^{th} floors and then heading to the ground floor. The algorithm may use the time of day as an input, for example assuming early in the day that most calls are going to be from the ground floor going to elevations and that later in the day most calls are from elevations wanting to get to ground, so that in between calls, the elevator may be positioned accordingly.

The algorithm may include a learning capability, so that idiosyncrasies of the particular building site may be taken into account, thus some sites may have changeovers of shifts at particular times. Building sites are by their nature temporary and the nature of building is such that the process is dynamic, so that the usual state of the algorithm will be that it is learning new routines most of the time. Thus it is in the nature of a building site that particular floors are being more heavily worked on at any given time, and the algorithm may adapt accordingly.

In an embodiment, the system may determine how much time passes between an elevator call being issued at a given floor and arrival of the elevator. In a further embodiment, the people counter 30 obtains data of the number of people in the elevator at any given time. Processing may determine the change at any given floor and thus the number of people who waited for the elevator at that floor may be determined. Thus the system may be able to determine the number of person-hours spent waiting for the elevator.

The numbers may be used to study the efficiency of the building site and may be used to improve the algorithm. Thus if it is found that certain floors generally have larger numbers of people then they can be given priority over floors that have fewer people to reduce the total person hours spent waiting.

The door open detector may relate to an elevator door which is built on the structure 16 rather than part of the enclosure itself. Today an elevator is prevented from operation by an open door but there is no information as to which door is open, so that the operator has to climb up from floor to floor to check each door until the culprit is found and closed. The present embodiments may allow door state detection associated with each door at each floor along with the wireless call button, so that the operator may know immediately which floor to find the problem.

The algorithm may provide input directly to operate the hoist or it may provide its input as a recommendation to the operator, recommending which floor to send the elevator to.

The algorithm may include an override facility, so that for example emergencies may be dealt with or someone such as the site foreman may be able to call the elevator without delay.

As discussed, processing, logging of data, and issuing of operational commands may be made from an application located in the cloud. Typically connection to the cloud is wireless, via a locally available Wi-Fi or like network or via the cellular network. In addition, the mobile application may allow for local control of the system. The mobile application may connect directly to the datalogger or via the cloud. The mobile application may be used by the operator, and/or may be used by other personnel to override the operator.

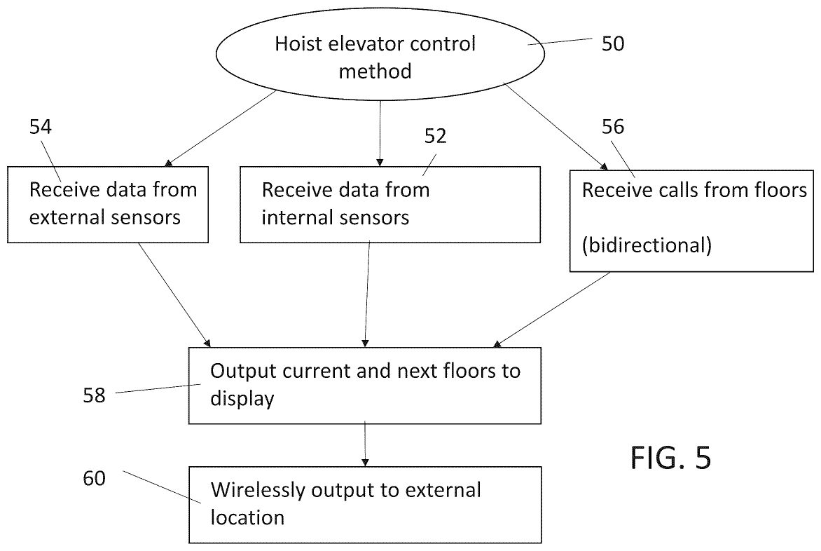

Reference is now made to FIG. 5, which illustrates operation of the hoist elevator control system of FIG. 3 according to an embodiment of the present invention.

The hoist elevator control method 50 operates on a hoist elevator attached to a multi-story building structure, the elevator comprising an enclosure for raising and lowering personnel and materials between the floors of the multi-story structure as discussed. The method involves receiving 52 data from sensors that are external to the enclosure, such as door status sensors and windspeed sensors. Data is also received 54 from sensors internal to the enclosure, such as people counters. Data is wirelessly received 56 from call buttons which are located at each floor. The data received at the data logger from a call button is of two types, a call to the elevator to say that someone is waiting at a given floor, which call may be bidirectional, wanting to go up or down, and the other type is data indicating which floor is in proximity.

The use of bidirectional data from the call button means that a next floor can be calculated and the method involves outputting 58 to a display screen in the enclosure indications of the current floor and the next floor at which the elevator is going to stop. The method further involves wirelessly outputting 60 data to an external location such as a control application located on a mobile device or a cloud application for processing and logging of the data.

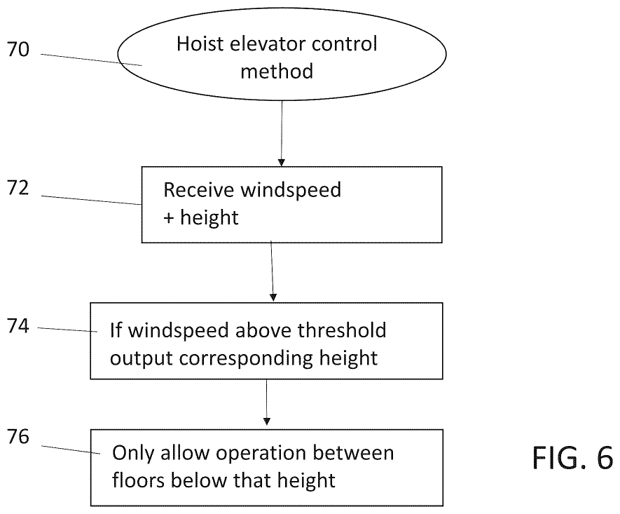

Reference is now made to FIG. 6, which is a simplified diagram showing a method 70 of control of the hoist elevator according to embodiments of the present invention which may be used additionally or alternatively to that in FIG. 5.

Data is obtained 72 from windspeed sensors at different heights on the structure. The data may include windspeed and associated height. In any case where the windspeed is above a predetermined speed, the corresponding height is output 74, and then information is provided to the operator who is able to ensure that operation of the hoist elevator is only allowed at heights below the height that is output—76. A typical maximum safe windspeed is 40 kmh, and such a speed may be measured at the tenth floor, but all speeds below the tenth floor are below the threshold. Thus operation of the elevator may be allowed up to the ninth floor.

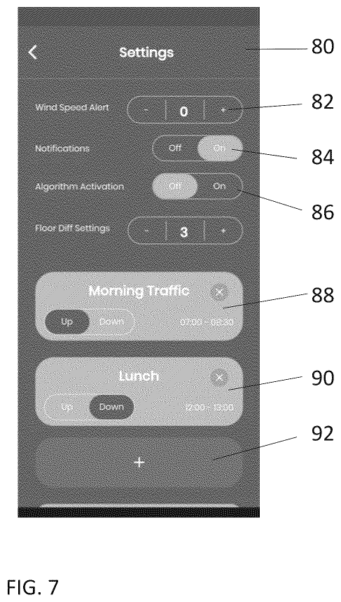

Reference is now made to FIG. 7, which is a simplified diagram showing the screen of a mobile or desktop or other application for operating the hoist elevator. Screen 80 has several regions that relate to the control of the hoist elevator. Region 82 relates to windspeed. In the windspeed region an alert is provided to the operator regarding the windspeed. The alert may indicate floors at which travel is not allowed due to the windspeed, or the alert may show the highest floor to which travel is safe or the lowest floor at which travel is unsafe, or may indicate that no travel is safe or may indicate that all floors are safe.

A notification region 84 may allow the operator to receive notifications. The notifications may come from overall cloud-based supervision of the elevators, or from sensors on the local elevator or even from occupants of the elevators. An activation region 86 may activate and deactivate algorithmic operation of the elevator. Further regions, such as morning traffic region 88 and lunch region 90 may activate particular features of the algorithmic operation. Thus in the morning the algorithm may assume that most users are being taken from the ground and raised to heights so that the elevator will tend to move to the ground floor when not in use in anticipation that the next journey starts from the ground. At lunchtime the algorithm may assume that at the start, journeys begin at elevation and end at the ground and towards the end of the lunch break the journeys begin at the ground and head upwards. Other areas may be added 90.

In the present embodiment, the algorithm selects a next floor for the operator's approval and the operator either accepts or rejects the selection. In other embodiments the elevator may be controlled directly.

It is expected that during the life of a patent maturing from this application many relevant hoists and sensors will be developed and the scopes of these and other terms herein are intended to include all such new technologies a priori.

The terms “comprises”, “comprising”, “includes”, “including”, “having” and their conjugates mean “including but not limited to”.

The term “consisting of” means “including and limited to”.

As used herein, the singular form “a”, “an” and “the” include plural references unless the context clearly dictates otherwise.

It is appreciated that certain features of the invention, which are, for clarity, described in the context of separate embodiments, may also be provided in combination in a single embodiment and the present description is to be construed as if such embodiments are explicitly set forth herein. Conversely, various features of the invention, which are, for brevity, described in the context of a single embodiment, may also be provided separately or in any suitable subcombination or may be suitable as a modification for any other described embodiment of the invention and the present description is to be construed as if such separate embodiments, subcombinations and modified embodiments are explicitly set forth herein. Certain features described in the context of various embodiments are not to be considered essential features of those embodiments, unless the embodiment is inoperative without those elements.

Although the invention has been described in conjunction with specific embodiments thereof, it is evident that many alternatives, modifications and variations will be apparent to those skilled in the art. Accordingly, it is intended to embrace all such alternatives, modifications and variations that fall within the spirit and broad scope of the appended claims.

All publications, patents and patent applications mentioned in this specification are herein incorporated in their entirety by reference into the specification, to the same extent as if each individual publication, patent or patent application was specifically and individually indicated to be incorporated herein by reference. In addition, citation or identification of any reference in this application shall not be construed as an admission that such reference is available as prior art to the present invention. To the extent that section headings are used, they should not be construed as necessarily limiting. In addition, any priority document(s) of this application is/are hereby incorporated herein by reference in its/their entirety.

1. A hoist elevator control system and a hoist elevator, the hoist elevator attached to a multi-story building structure of an incomplete building on a building site, the elevator comprising an enclosure for raising and lowering personnel and materials in said multi-story structure, the control system comprising at least one sensor external to said enclosure, at least one sensor internal to said enclosure, a call button at each floor, and a processor located within the enclosure, the processor configured to obtain data from each of said at least one sensor internal to said enclosure, said at least one sensor external to said enclosure and said call buttons, and to output data to a display screen in said enclosure and to an external control location, and wherein said at least one internal sensor is a people counter, the people counter being configured to issue an alarm to prevent operation when said enclosure has more than a preset number of people within, the people counter further configured to send a current number of people within to said processor for processing, the data allowing an operator to control said elevator.

2. The hoist elevator control system of claim 1, wherein said at least one external sensor is a windspeed detector, the windspeed detector being configured to issue an alarm to prevent operation of said hoist elevator when a detected windspeed is above a predetermined limit.

3. The hoist elevator control system of claim 2, comprising one member of the group consisting of a windspeed detector located on the elevator and a plurality of windspeed detectors at different heights, the control system configured to indicated safe operation of said hoist elevator only up to floors below a height at which a detected windspeed is above a predetermined level.

4. The hoist elevator control system of claim 1, wherein said at least one external sensor is a door status sensor to detect whether a door at a given floor is open or closed, to indicate a floor at which said door is open.

5. The hoist elevator control system of claim 1, wherein at least some of said call buttons are bidirectional call buttons, said control system being configured to use direction information from said call buttons to calculate a next floor for said elevator.

6. The hoist elevator control system of claim 1, wherein said processor is at least partly battery powered.

7. The hoist elevator control system of claim 1, wherein said processor is at least partly powered by a solar panel.

8. A hoist elevator control method for a hoist elevator attached to a multi-story building structure of an incomplete building on a building site, the elevator comprising an enclosure for raising and lowering personnel and materials in said multi-story structure, the control method comprising:
receiving data from at least one sensor external to said enclosure;
receiving data from at least one sensor internal to said enclosure, said at least one internal sensor being a people counter, the people counter issuing an alarm to prevent operation when said enclosure has more than a preset number of people within, and sending a current number of people within to said processor for processing;
wirelessly receiving calls from call buttons at each floor;
outputting to a display screen in said enclosure indications of a current floor and a next floor at which said elevator stops;
wirelessly outputting data to an external location: and
using said data to control said hoist elevator.

9. A hoist elevator control system, a hoist elevator and an application for a telephone, the hoist elevator attached to a multi-story building structure of an incomplete building on a building site, the elevator comprising an enclosure for raising and lowering personnel and materials between floors of said multi-story structure, the control system comprising at least one sensor external to said enclosure, at least one sensor internal to said enclosure, and a processor located within the enclosure, the processor configured to obtain data from each of said at least one sensor internal to said enclosure, said at least one sensor external to said controller, and to output data to a display screen in said enclosure and to an external control location, the control system being configured to open a communication channel with said telephone application to control said hoist elevator from said telephone application.

10. The control system, hoist elevator and application of claim 9, wherein said communication channel is configured to carry information of said at least one internal sensor.

11. The control system, hoist elevator and application of claim 9, wherein said communication channel is configured to carry information of said at least one external sensor.

12. The control system, hoist elevator and application of claim 9, further comprising call buttons at respective ones of said floors.

13. The control system, hoist elevator and application of claim 9, wherein said call buttons are wirelessly connected to said control system.

14. The control system, hoist elevator and application of claim 13, wherein said communication channel is configured to carry calls of said call buttons to said telephone application.

15. The control system, hoist elevator and application of claim 9, wherein said at least one internal sensor is a people counter, the people counter being configured to issue an alarm to prevent operation when said enclosure has more than a preset number of people within, the people counter further configured to send a current number of people within to said communication channel for processing at said telephone application, thereby allowing said telephone application to control said elevator.

16. The method of claim 8, comprising:
obtaining data from a plurality of windspeed sensors at different floors on the structure; and
allowing operation of the hoist elevator only up to a floor below a height at which a corresponding one of the windspeed sensors detects a windspeed above a predetermined limit.

17. The hoist elevator control method of claim 16, comprising obtaining windspeed data from windspeed sensors located at each floor.

18. The hoist elevator control method of claim 16, further comprising communicating with a telephone application and controlling said hoist elevator from said telephone application.
